(19) United States
(12) Patent Application Publication
(10) Pub. No.: US 2014/0310113 A1
(43) Pub. Date: Oct. 16, 2014

(54) CLOUD BASED CREDIT CARD EMULATION

(71) Applicants: Uttam Sengupta, Portland, OR (US); Sanjay Bakshi, Portland, OR (US)

(72) Inventors: Uttam Sengupta, Portland, OR (US); Sanjay Bakshi, Portland, OR (US)

(21) Appl. No.: 13/977,203

(22) PCT Filed: Oct. 1, 2011
(86) PCT No.: PCT/US11/54499

§ 371 Date: Nov. 21, 2013

(51) Int. Cl. G06Q 20/20; G06Q 20/40

(52) U.S. Cl. CPC G06Q 20/202; G06Q 20/409; G06Q 20/204
USPC 705/17

(57) ABSTRACT

In some embodiments, an electronic device comprises an input interface, a communication interface, a processor, and logic to initiate, in the electronic device, a secure communication session with a credit server, select at least one credit source, receive, in the electronic device, a payment credential associated with the at least one credit source, receive, from a point of sale device, a request for payment information for a purchase transaction, wherein the request specifies a predetermined format for the payment information, format, in the electronic device, payment information comprising the payment credentials in the predetermined format, and transmit the payment information from the phone to the point of sale device. Other embodiments may be described.

### BACKGROUND

The subject matter described herein relates generally to the field of electronic commerce and more particularly to systems and methods for cloud-based credit card emulation.

Currently, most consumer use physical credit or debit cards or other physical stored value cards to complete commercial transactions. The relative ubiquity of electronic devices has raised the prospect of implanting “virtual” credit or debit cards in electronic devices.

### BRIEF DESCRIPTION OF THE DRAWINGS

The detailed description is described with reference to the accompanying figures.

FIG. 1 is a schematic illustration of an exemplary electronic device which may be adapted to implement cloud-based credit card emulation, in accordance with some embodiments.

FIG. 2 is a high-level schematic illustration of an exemplary architecture for cloud-based credit card emulation, in accordance with some embodiments.

FIG. 3 is a schematic illustration of an exemplary system for cloud-based credit card emulation, in accordance with some embodiments.

FIGS. 4-5 are flowcharts illustrating operations implemented in an exemplary system for cloud-based credit card emulation, in accordance with some embodiments.

### DETAILED DESCRIPTION

Described herein are exemplary systems and methods for cloud-based credit card emulation. A mobile device such as a mobile phone or the like is configured to include a virtual credit card module that executes on the mobile device. This virtual credit card module may execute in a trusted execution environment on the mobile device, such that the virtual credit card module is secured from other applications on the device. The virtual credit card module enables the mobile device to interact with point of sale device(s) and payment networks to emulate a virtual credit card. In some embodiments the credit card information is stored in the cloud, rather than on the mobile device. In operation, the electronic device initiates a secure communication connection with a credit server that stores the credit card information and provides it with a device authentication token generated based on previously issued device credentials. A credit source is selected from credit information associated with the device or with a user of the device. In response to the selection, the credit server forwards to the electronic device a single use payment credential associated with the selected payment source to the electronic device. The payment credential may then be used in a purchase transaction at point of sale terminal. For example, in a purchase transaction a point of sale terminal may request payment information from the user of the electronic device. The electronic device may provide the payment credential to the point of sale device. In some embodiments, per the credit card server and end user defined policies, virtual credit card module may store a finite number of single use payment credentials that are pre-sourced from credit card server to handle situations when connectivity to credit card server is not possible.

In some embodiments the transaction may be completed based on the payment credentials provided to the point of sale device. In other embodiments additional authentication steps may be added to a purchase transaction protocol. For example, in some embodiments an authentication process may be invoked to authenticate a user the electronic device, a location of the electronic device or an identity of the electronic device. In some embodiments the point of sale device forwards the payment credentials and transaction information to a payment server, which approves or denies the purchase transaction. If the transaction is approved the payment server may forward an approval code to the electronic device, which may then be provided to the point of sale device.

In some embodiments the payment server will invoke additional authorization steps for the consumer to authorize the transaction received from the merchant. In some embodiments the payment server may present coupons relevant to purchased items to the consumer for selection.

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

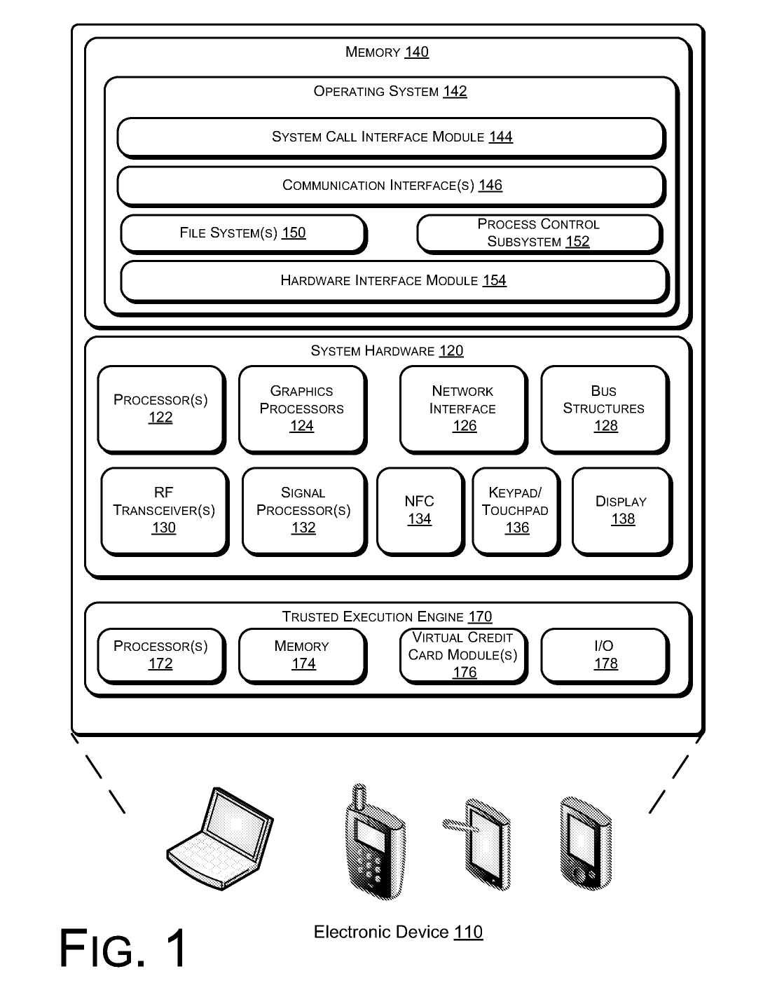

FIG. 1 is a schematic illustration of an exemplary electronic device 110 which may be adapted to implement client hardware authenticated transactions in accordance with some embodiments. As illustrated in FIG. 1, electronic device 110 may be embodied as a conventional mobile device such as a mobile phone, tablet computer portable computer, or personal digital assistant (PDA).

In various embodiments, electronic device 110 may include or be coupled to one or more accompanying input/output devices including a display, one or more speakers, a keyboard, one or more other I/O device(s), a mouse, or the like. Exemplary I/O device(s) may include a touch screen, a voice-activated input device, a track ball, a geolocation device, an accelerometer/gyroscope, biometric feature input devices, and any other device that allows the electronic device 110 to receive input from a user.

The electronic device 110 includes system hardware 120 and memory 140, which may be implemented as random access memory and/or read-only memory. A file store may be communicatively coupled to computing device 110. The file store may be internal to computing device 110 such as, e.g., eMMC, SSD, one or more hard drives, or other types of storage devices. File store 180 may also be external to computer 110 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 110 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 110 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 110 may further include one or more input/output interfaces such as, e.g., a keypad 158 and a display 160. In some embodiments electronic device 110 may not have a keypad and use the touch panel for input.

Memory 140 may include an operating system 142 for managing operations of computing device 110. In one embodiment, operating system 142 includes a hardware interface module 154 that provides an interface to system hardware 120. In addition, operating system 140 may include a file system 150 that manages files used in the operation of computing device 110 and a process control subsystem 152 that manages processes executing on computing device 110.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

Electronic device 110 may comprise a trusted execution engine 170. In some embodiments the trusted execution engine 170 may be implemented as an independent integrated circuit located on the motherboard of the electronic device 110, while in other embodiments the trusted execution engine 170 may implemented as a dedicated processor block on the same SOC die, while in other embodiments the trusted execution engine may be implemented on a portion of the processor(s) 122 that is segregated from the rest of the processor(s) using HW enforced mechanisms

In the embodiment depicted in FIG. 1 the trusted execution engine 170 comprises a processor 172, a memory module 174, a credit card module 176, and an I/O module 178. In some embodiments the memory module 174 may comprise a persistent flash memory module and the virtual credit card module 176 may be implemented as logic instructions encoded in the persistent memory module, e.g., firmware or software. The I/O module 178 may comprise a serial I/O module or a parallel I/O module. Because the trusted execution engine 170 is separate from the main processor(s) 122 and operating system 142, the trusted execution engine 170 may be made secure, i.e., inaccessible to hackers who typically mount SW attacks from the host processor 122

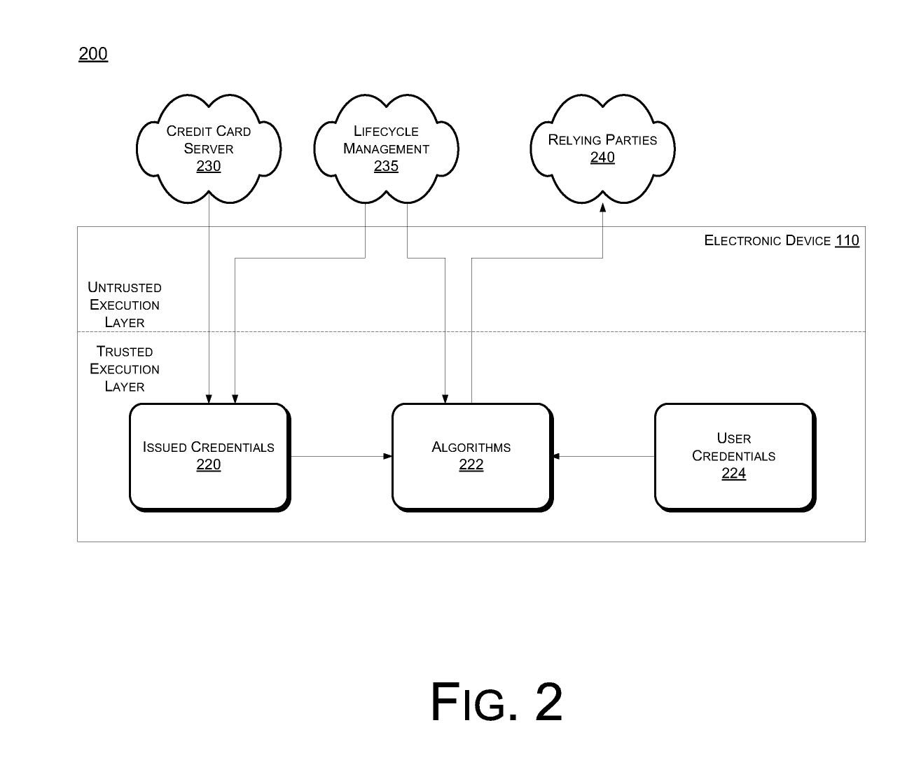

In some embodiments the trusted execution engine 170 may be used to implement credit card emulation operations in a host electronic device. FIG. 2 is a high-level schematic illustration of an exemplary architecture for credit card emulation in accordance with some embodiments. Referring to FIG. 2, an electronic device 110 may be characterized as having an untrusted execution layer and a trusted execution layer. When the electronic device 110 is embodied in accordance with the description provided in FIG. 1, the trusted execution layer may be implemented by the trusted execution engine 170, while the untrusted domain may be implemented by the main processors(s) 122 and operating system 142 of the electronic device 110. As illustrated in FIG. 2, remote entities that issue credentials, identified as credit card server(s) 230 in FIG. 2, supply credentials, which are stored in the trusted domain of the electronic device 110. In use, the issued credentials and one or more user credentials 224 may be provided as inputs to one or more authentication algorithms 222, which process the credentials, which may be provided to one or more relying parties 240. Integrity of the trusted domain may be maintained through exclusive, cryptographically-protected, relationships between a trusted domain and entities that are allowed to issue credentials into 220 or lifecycle manage 235 the contents and algorithms 222 of the trusted domain.

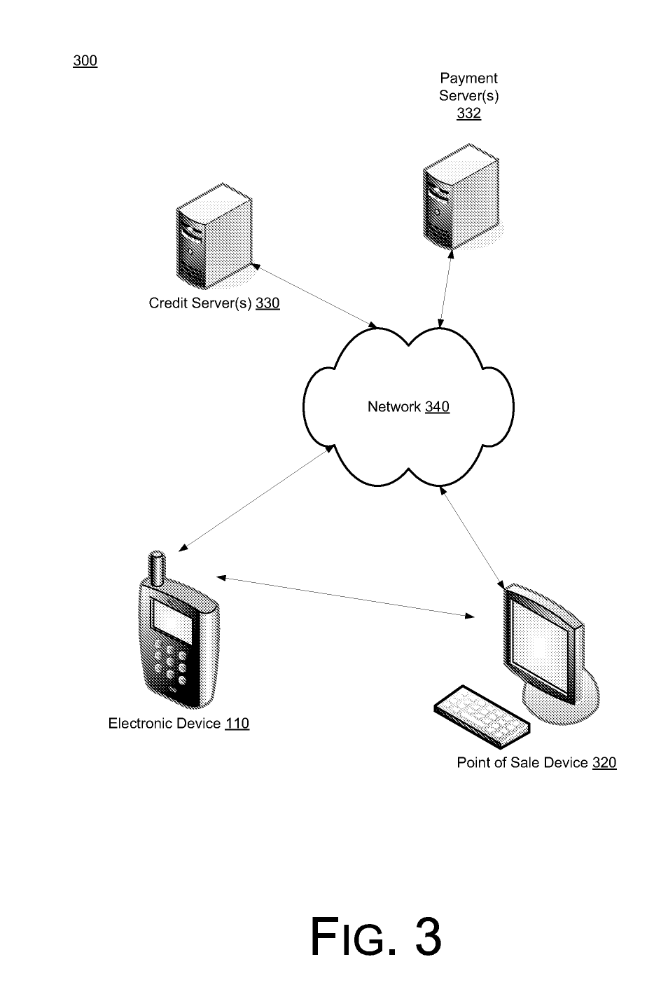

FIG. 3 is a schematic illustration of a system for mobile device credit card emulation according to some embodiments. Referring to FIG. 3, an electronic device 110 may be coupled to one or more servers 330, 332 via a network 340. In addition, a point of sale device 320 may be coupled to network 340 and may comprise a wireless interface to enable wireless communication with electronic device 110. In some embodiments electronic device 110 may be embodied as a mobile telephone, tablet, PDA or other mobile computing device as described with reference to electronic device 110, above. Network 340 may be embodied as a public communication network such as, e.g., the internet, or as a private communication network, or combinations thereof.

Servers 330, 332 may be embodied as computer systems. In some embodiments the server 330 may be embodied as a credit server and may be managed by a vendor or by a third party which operates secure platform. Payment server(s) 132 may be operated by a vendor or by a third-party payment system, e.g., a transaction clearing service or a credit card service.

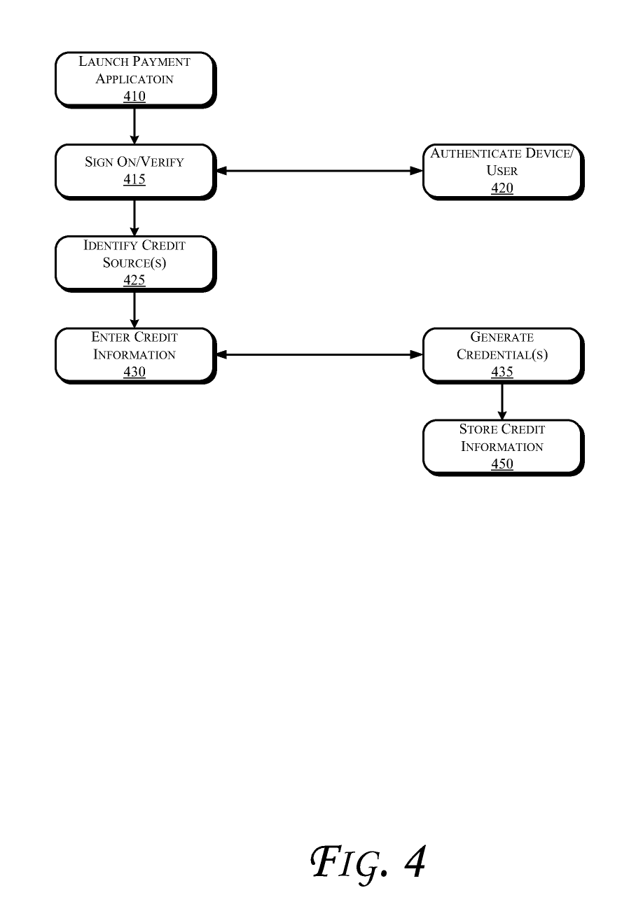

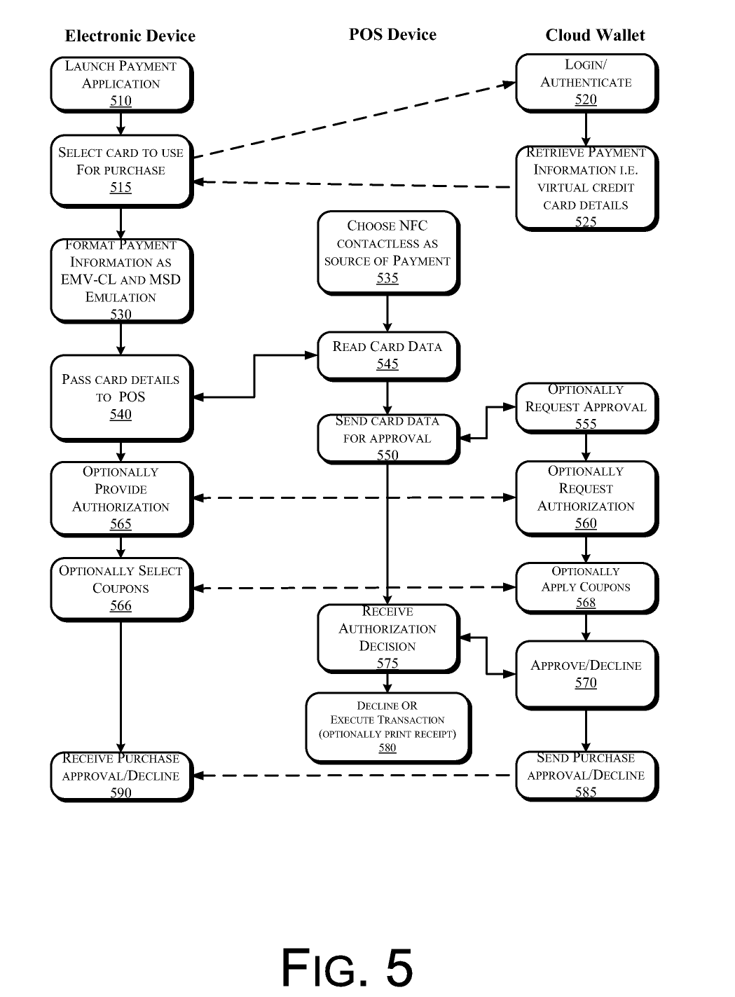

In some embodiments, electronic device 110, in cooperation with the point of sale device 320 and one or more of the servers 330, 332 may be configured to facilitate virtual credit card emulation. FIGS. 4-5 are flowcharts illustrating operations implemented to emulate credit card operations, according to some embodiments. In some embodiments the operations depicted in FIG. 4 enable a user to store credit source information in a server such as credit card server 230. Referring first to FIG. 4, at operation 410 a virtual credit card module 176 is launched on an electronic device 110, e.g., on the processor(s) 172 in the trusted execution environment.

By way of example, in some embodiments a user may launch a payment application which by entering an input on a user interface of the electronic device 110. Alternatively, the payment application may launch automatically in response to detecting a condition. For example, a payment application may detect when the electronic device is within a predetermined distance of a retail store operated or a point of sale device.

At operation 415 a user of the electronic device signs on to a credit card server, e.g., by entering a username and a password. In response to a login operation the electronic device 110 initiates a communication session with a credit server 330, which authenticates (operation 420) at least one of the electronic device 110 or the user of the electronic device. In some embodiments the authentication process may incorporate additional techniques besides user name/password combinations. By way of example, the authentication process may include one or more challenge-response components such as a Completely Automated Public Turing test to tell Computers and Humans Apart (“CAPTCA”) test, multi-factor authentication (e.g., biometrics) and one time passwords (OTP)

In alternate embodiments, or in addition, the authentication process may include a location-based authentication process that determines whether the electronic device is within a predetermined location. For example, the authentication process may utilize a geolocation service to determine whether the electronic device is within a predetermined location. Alternatively, in some embodiments the credit card module 176 may cause the electronic device 110 to transmit a signal which may be detected by a receiver in a point of sale device. The receiver device may, in turn, report the location of the electronic device 110 to the shopping server 130 via a network 140.

At operation 425 the payment application identifies one or more credit sources. By way of example, in some embodiments a user of the electronic device may enter (operation 430) credit card information for one or more credit cards owned by the user. The credit card information transmitted from the electronic device 110 to a credit server 330, and at operation 435 the credit server 330 generates one or more payment credentials associated with the credit card information. At operation 450 the credit information and credentials are stored in a memory module coupled to credit server 330, e.g., in a database or the like.

FIG. 5 is a flowchart illustrating operations in one embodiment of a purchase transaction. Referring to FIG. 5, at operation 510 a user launches a payment application on the electronic device. At operation 515 the user selects a payment source such as a credit or debit card to use for the purchase transaction. In some embodiments information identifying the payment source(s) may be stored locally in the electronic device 110, while in other embodiments the credit server(s) 330 may retrieve the user's credit information uploaded in FIG. 4 and may present information identifying the user's payment source(s) for the transaction.

In response, the electronic device initiates a session with the user's cloud wallet on the credit server 330, which implements a login/authentication process at operation 520. At operation 525 the cloud wallet on credit server 330 retrieves virtual credit card details from memory and transmits the information back to the electronic device 110.

At operation 530 the electronic device 110 formats the payment information in accordance with a specified format, for example an EMV-CL or MSD Emulation. At operation 535 the user enters an input into the point of sale device 320 to select a contactless payment transaction as a source of payment. At operation 540 the user performs a transaction verification step. For example, in some embodiments the user may be required to tap the electronic device 110 on the point of sale device 320 and pass the formatted payment information via NFC with device 110 acting in NFC card emulation mode. Alternatively it is also possible to pass this information from device 110 to point of sale device 320 via NFC Peer to Peer protocol, or as a QR code that is displayed on device's 110 display and scanned via a QR code reader connection point of sale 320, or via an audio signal e.g. as ultrasound. Other and/or additional transaction verification steps may include entering exchanging electronic codes between electronic device 110 and point-of-sale device 320 or positioning the electronic device 110 in a specified location relative to point of sale device 320. At operation 545 the point of sale device 320 reads the payment source data from the electronic device 110.

At operation 550 the point of sale device 320 sends the card data to the cloud wallet in the credit server 330 which, at operation 555, may request approval for the transaction from a payment server 332. At operation 560 the cloud wallet may optionally request an authorization from the electronic device 110, which may optionally provide the authorization at operation 565. At operation 565 user may be shown the details about the transaction e.g. the originating merchant name or identifier and other transaction details and then be asked to authorize the transaction by entering a PIN or some other information.

In some instances a user may have coupons or discount codes to apply to the transaction. Thus, at operation 566 a user may optionally select a coupon or discount code, which is transmitted to the cloud wallet on the credit server 330, which optionally may apply the coupons/discount codes at operation 568.

At operation 570 a decision to either approve or decline the transaction is made and received by the point of sale device 320 at operation 575. At operation 580 the point of sale device either declines or executes the transaction in accordance with the approve/decline decision made at operation 570.

At operation 585, the approval or decline decision notification is transmitted from the cloud wallet in the credit server 330 to the electronic device 110 (operation 585). The electronic device receives (operation 590) the purchase notification, a record of which may be stored in a memory such as memory 174 of trusted execution engine 170 or in the memory 140 of the device.

Thus, described herein is a system and method to enable an electronic device such as a mobile phone or the like to be used as a virtual credit card, and wherein sensitive information about the credit card are stored in the cloud, rather than on the electronic device.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-24. (canceled)

25. A computer program product comprising logic instructions stored on a non-transitory computer readable medium, which when executed by a processor in an electronic device, configure the processor to implement credit card emulation operations, comprising:
initiating, in the electronic device, a secure communication with a credit server;
transmitting, from the electronic device, a signal to select at least one credit source;
receiving, in the electronic device, a payment credential associated with the at least one credit source;
receiving, from a point of sale device, a request for payment information for a purchase transaction, wherein the request specifies a predetermined format for the payment information;
formatting, in the electronic device, payment information comprising the payment credentials in the predetermined format; and
transmitting the payment information from the electronic device to the point of sale device.

26. The computer program product of claim 25, wherein the credit card emulation operations further comprise:
receiving, in the point of sale device, the payment information from the electronic device; and
transmitting the payment information and transaction information associated with a transaction from the point of sale device to a payment server.

27. The computer program product of claim 26, wherein the credit card emulation operations further comprise initiating an authentication process to authenticate at least one of a user of the electronic device, a location of the electronic device, or the identity of the electronic device.

28. The computer program product of claim 27, wherein the authentication process comprises implementing a predetermined course of action between the electronic device and the point of sale device.

29. The computer program product of claim 26, wherein payment server presents one or more coupons for the transaction via a second communication channel.

30. The computer program product of claim 26, wherein payment server authorizes payment for the transaction and transmits a transaction approval notification to the point of sale device via a first communication channel and to the electronic device via a second communication channel, wherein the transaction approval notification comprises an approval code.

31. The computer program product of claim 30, further comprising:
receiving the transaction approval in the electronic device; and
providing the approval code from the electronic device to the point of sale device.

32. The computer program product of claim 31, wherein, in response to receiving the transaction approval notification and the approval code, the point of sale device executes the transaction.

33. An electronic device, comprising:
an input interface;
a communication interface;
a processor; and
logic to:
initiate, in the electronic device, a secure communication with a credit server;
select at least one credit source;
receive, in the electronic device, a payment credential associated with the at least one credit source;
receive, from a point of sale device, a request for payment information for a purchase transaction, wherein the request specifies a predetermined format for the payment information;
format, in the electronic device, payment information comprising the payment credentials in the predetermined format; and
transmit the payment information from the electronic device to the point of sale device.

34. The electronic device of claim 33, further comprising initiating an authentication process to authenticate at least one of a user of the electronic device, a location of the electronic device, or the identity of the electronic device.

35. The electronic device of claim 34, wherein the authentication process comprises implementing a predetermined course of action between the electronic device and the point of sale device.

36. The electronic device of claim 34, wherein payment server authorizes payment for the transaction and transmits a transaction approval notification to the point of sale device via a first communication channel and to the electronic device via a second communication channel, wherein the transaction approval notification comprises an approval code.

37. The electronic device of claim 37, further comprising logic to:
receive the transaction approval in the electronic device; and
provide the approval code from the electronic device to the point of sale device.

38. The electronic device of claim 37, wherein, in response to receiving the transaction approval notification and the approval code, the point of sale device executes the transaction.

39. A computer program product comprising logic instructions stored on a non-transitory computer readable medium, which when executed by a processor in a point of sale device, configure the processor to implement credit card emulation operations, comprising:
initiating, in the point of sale device a request for payment information for a purchase transaction, wherein the request specifies a predetermined format for the payment information
receiving, in response to the request, a payment credential associated with the at least one credit source from an electronic device;
transmitting an approval request comprising the payment credential received from the electronic device to a payment server;
receiving, in the point of sale device, an authorization decision for a purchase transaction; and
processing the purchase transaction in accordance with the authorization decision.

40. The computer program product of claim 39, wherein the credit card emulation operations further comprise detecting an input which selects a contactless source of payment.

41. The computer program product of claim 39, wherein processing the purchase transaction in accordance with the authorization decision comprises:
receiving a decision to deny the purchase transaction; and
declining the purchase transaction at the point of sale device

42. The computer program product of claim 39, wherein processing the purchase transaction in accordance with the authorization decision comprises:
receiving a decision to authorize the purchase transaction; and
approving the purchase transaction at the point of sale device

43. The computer program product of claim 42, wherein processing the purchase transaction in accordance with the authorization decision further comprises:
printing a transaction record.

44. A point of sale device, comprising:
an input interface;
a communication interface;
a processor; and
logic to:
initiate, in the point of sale device a request for payment information for a purchase transaction, wherein the request specifies a predetermined format for the payment information
receive, in response to the request, a payment credential associated with the at least one credit source from an electronic device;
transmit an approval request comprising the payment credential received from the electronic device to a payment server;
receive, in the point of sale device, an authorization decision for a purchase transaction; and
process the purchase transaction in accordance with the authorization decision.

45. The point of sale device of claim 44, further comprising logic to detect an input which selects a contactless source of payment.

46. The point of sale device of claim 44, further comprising logic to:
receive a decision to deny the purchase transaction; and
decline the purchase transaction at the point of sale device

47. The point of sale device of claim 44, further comprising logic to:
receive a decision to authorize the purchase transaction; and
approve the purchase transaction at the point of sale device

48. The point of sale device of claim 44, further comprising logic to:
print a transaction record.
